(19) United States
(12) Patent Application Publication
(10) Pub. No.: US 2020/0032755 A1
(43) Pub. Date: Jan. 30, 2020

(54) FUEL INJECTION DEVICE

(71) Applicant: HITACHI, LTD., Tokyo (JP)

(72) Inventors: Eiji ISHII, Tokyo (JP); Kazuki YOSHIMURA, Tokyo (JP); Yoshihito YASUKAWA, Tokyo (JP)

(73) Assignee: HITACHI, LTD., Tokyo (JP)

(21) Appl. No.: 16/488,177

(22) PCT Filed: Jan. 30, 2018
(86) PCT No.: PCT/JP2018/002840

§ 371 Date: Aug. 22, 2019

(30) Foreign Application Priority Data
Feb. 24, 2017 (JP) 2017-032815

(51) Int. Cl. F02M 61/18; F02M 55/00

(52) U.S. Cl. CPC F02M 61/1813; F02M 55/008; F02M 51/061; F02M 61/1826; F02M 61/1886

(57) ABSTRACT

Movement of a valve body in an unspecified direction due to a minute clearance existing between a valve body and a guide changes the flow of fuel flowing into injection holes every injection, thereby leading to variation in respective beams of spray from the injection holes and the flow rate of injection between the injection holes. Provided are a valve body that sits on or separates from a seat; a plurality of guides that slidably guide the valve body; and a plurality of flow channel portions each formed between each guide adjacent circumferentially. Then, among the plurality of flow channel portions, the cross-sectional area of the first flow channel portion on a horizontal plane orthogonal to the central axis of the valve body is smaller than each of the cross-sectional areas of the remaining flow channel portions on the horizontal plane.

### TECHNICAL FIELD

The present invention relates to a fuel injection valve included in an internal combustion engine such as a gasoline engine, in which a valve abutting against a valve seat prevents fuel leakage and the valve separating from the valve seat allows fuel injection.

### BACKGROUND ART

According to one of conventional inventions, for a positional shift between the central axis of an injection hole and the central axis line of a suck chamber, on the basis of the amount of positional shift between the central axis line of the injection hole and the central axis line of the suck chamber, the respective fuel-passage cross-sectional areas of at least two fuel passage ports are changed such that fuel spray is injected in a desired direction from the injection hole.

Another conventional invention includes a swirl applying means that applies a swirling motion to fuel on the upstream side of the injection hole, and at least one of swirl slots provided with the swirl applying means has a flow channel with a cross-sectional area larger than the respective cross sectional areas of the other slots, whereby forming spray with directivity.

### CITATION LIST

### Patent Literature

PTL 1: JP 4893709 B2

PTL 2: JP 2004-36554 A

### SUMMARY OF INVENTION

### Technical Problem

A fuel injection device is required, in order to improve the combustion stability of an internal combustion engine, to reduce variation in the flow rate and injection direction for respective beams of spray injected from injection holes and variation in the flow rate of injection between all the injection holes, every injection with the fuel injection device. An unstable radial force acting on a valve body during valve opening results in movement of the valve body in an unspecified direction due to a minute clearance existing between the valve body and a guide. Thus, the flow of fuel flowing into the injection holes changes every injection, thereby raising an issue of variation in the respective beams of spray and the flow rate of injection.

PTL 1 of the above conventional invention discloses the invention of injection in a desired direction for the fuel injection device having the single injection hole. However, for a fuel injection device having a number of injection holes, it is difficult to define the amount of positional shift between the central axis line of each injection hole and the central axis line of the suck chamber. Furthermore, it is difficult to optimize the respective fuel-passage cross-sectional areas corresponding to each of the amount of positional shift.

For PTL 2 of the above conventional invention, the positional shift leads to circumferential uniformity of the swirling motion, thereby making the control of the spray directivity difficult to the positional shift.

### Solution to Problem

In order to solve the above problems, according to the present invention, a fuel injection device includes: a valve body configured to sit on or separate from a seat; a plurality of guides configured to slidably guide the valve body; and a plurality of flow channel portions each formed between each guide adjacent circumferentially, in which, among the plurality of flow channel portions, the cross-sectional area of a first flow channel portion on a horizontal plane orthogonal to the central axis of the valve body is smaller than each of the cross-sectional areas of the remaining flow channel portions on the horizontal plane.

### Advantageous Effects of Invention

According to the present invention, for the fuel injection device, there can be reduced variation in the flow rate and injection direction for respective beams of spray injected from injection holes and variation in the flow rate of injection between all the injection holes, every injection with the fuel injection device. As a result, the combustion stability of an internal combustion engine.

Problems, configurations, and effects except those described above will be apparent from the description of the embodiments to be described later.

### BRIEF DESCRIPTION OF DRAWINGS

FIG. 1 is a cross-sectional view of an embodiment of a fuel injection valve according to a first embodiment of the present invention.

FIG. 2 is an enlarged cross-sectional view of an injection-hole formed member of a fuel injection device according to the first embodiment of the present invention.

FIG. 3 is an enlarged cross-sectional view of flow channels around fuel injection holes denoted by reference sign 3 in FIG. 1.

FIG. 4 is a view of a seat in FIG. 2 as viewed from above.

FIG. 5 is a fuel injection valve according to a second embodiment of the present invention having the number of flow channel portions in FIG. 4 changed to three locations.

FIG. 6 is a fuel injection valve according to a third embodiment of the present invention having each of the plurality of flow channel portions of FIG. 4 including a collection of flow channels each having a smaller cross-sectional area.

FIG. 7 is a fuel injection valve according to the third embodiment of the present invention having each of the plurality of flow channel portions of FIG. 5 including a collection of flow channels each having a smaller cross-sectional area.

FIG. 8 is a cross-sectional view of the fuel injection valve according to the second embodiment of the present invention, taken along the oblique-direction central axis parallel to the oblique direction of holes.

### DESCRIPTION OF EMBODIMENTS

Hereinafter, with reference to the drawings, embodiments of a fuel injection device according to the present invention will be described. In the drawings, the same elements will be denoted by the same reference signs and the redundant description will be omitted. Note that the present invention is not limited to the embodiments to be described later, and includes various modifications. For example, the embodiments to be described later will provide detailed description in order to facilitate explanation of the present invention, and are not necessarily limited to those having all the configurations to be described. In addition, part of the configuration of one embodiment can be substituted with the configurations of the other embodiments, and the configurations of the other embodiments can be added to the configuration of the one embodiment. Furthermore, additions, eliminations, and substitutions of the other configurations can be made for part of the respective configurations of the embodiments.

### First Embodiment

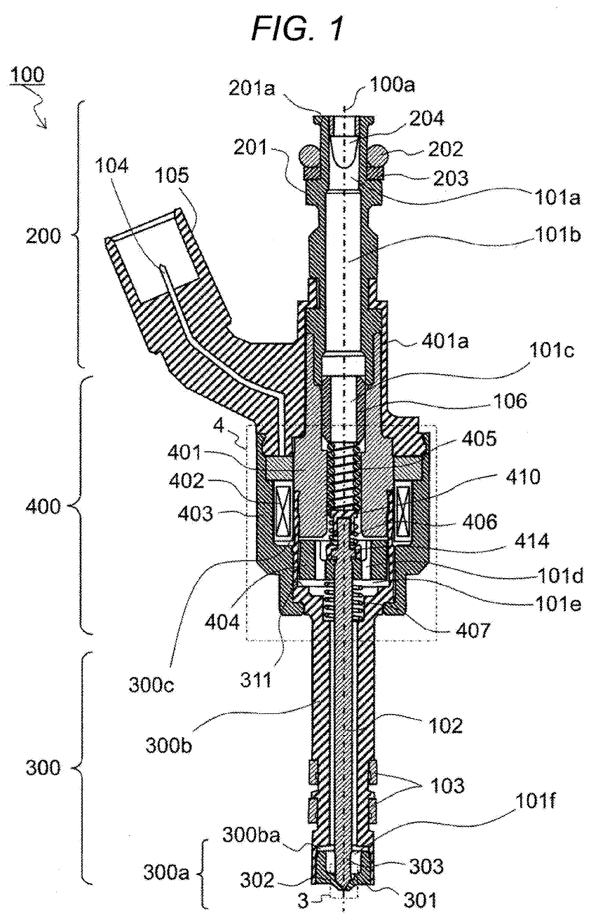

The configuration of a fuel injection device 100 according to a first embodiment will be described with FIGS. 1 to 4. The present embodiment will be described with taking, as an example, an electromagnetic fuel injection device for an internal combustion engine fueled by gasoline.

FIG. 1 is a cross-sectional view of the structure of the fuel injection device 100 according to the first embodiment. FIG. 1 is a longitudinal cross-sectional view of a cross section passing through the central axis line 100a of the fuel injection device 100.

The fuel injection device 100 includes a fuel supplier 200 that supplies fuel, a nozzle 300, and an electromagnetic driver 400. The nozzle 300 has a valve 300a provided at the leading end portion thereof, and allows and blocks fuel communication. The electromagnetic driver 400 drives the valve 300a. The present embodiment has the fuel supplier 200 disposed on the upper end side of the drawing and the nozzle 300 disposed on the lower end side in the drawing. The electromagnetic driver 400 is disposed between the fuel supplier 200 and the nozzle 300. That is, the fuel supplier 200, the electromagnetic driver 400, and the nozzle 300 are disposed in this order along the direction of the central axis line 100a. Hereinafter, according to the flow direction of fuel, there will be described the side on which the fuel supplier 200 is disposed with respect to the nozzle 300 is defined as the upstream side, and the side on which the nozzle 300 side is disposed with respect to the fuel supplier 200 is defined as the downstream side. Note that the fuel supplier 200, the valve 300a, the nozzle 300, and the electromagnetic driver 400 indicate corresponding parts with respect to the cross section illustrated in FIG. 1, and do not indicate a single component.

The fuel supplier 200 has fuel piping (not illustrated) coupled on the upstream side of the fuel supplier 200. The nozzle 300 is inserted into an attachment hole (insertion hole) formed in an intake pipe or a combustion-chamber formed member (e.g., cylinder block, or cylinder head) (not illustrated) of the internal combustion engine. The electromagnetic fuel injection device 100 receives the supply of fuel from the fuel piping through the fuel supplier 200, and injects the fuel from the leading end portion of the nozzle 300 into the intake pipe or the combustion chamber. The fuel injection device 100 includes fuel passages 101 (101a to 101f) therein so as to flow fuel along the substantial direction of the central axis line 100a of the electromagnetic fuel injection device 100, from the upstream side of the fuel supplier 200 to the downstream side of the nozzle 300.

The following description will describe both end portions in the direction along the central axis line 100a of the fuel injection device 100, with the end portion side on the upstream side defined as the base end side and the other end portion side on the downstream side defined as the leading end side. The end portion on the base end side indicates the base end portion of the fuel supplier 200, and the end portion on the leading end side of the nozzle 300 indicates the leading end portion. Furthermore, “upper” or “lower” in the following description will be described with respect to the up-and-down direction in FIG. 1. Such description, however, is not intended to even limit the mounting form of the fuel injection device to the internal combustion engine, to the up-and-down direction.

The fuel supplier 200 includes a fuel pipe 201. The fuel pipe 201 has a fuel supply port 201a provided at the upper end portion thereof. The fuel passage 101a is formed on the inner circumferential side of the fuel pipe 201. The fuel passage 101a passes through the fuel pipe 201 along the central axis line 100a. A fixed iron core 401 to be described later is joined at the lower end portion of the fuel pipe 201.

An O-ring 202 and a backup ring 203 are provided on the outer circumferential side of the upper end portion of the fuel pipe 201. The O-ring 202 functions as a seal that prevents fuel leakage in attachment of the fuel supply port 201a to the fuel piping. The backup ring 203 is provided for backing up the O-ring 202. The backup ring 203 may also have a plurality of ring-shaped members layered. A filter 204 is provided on the inner circumferential side of the fuel supply port 201a to filter out foreign matter entered in the fuel.

The nozzle 300 includes the valve 300a and a nozzle body 300b. The valve 300a is formed at the lower end portion of the nozzle body 300b. The nozzle body 300b has a hollow cylindrical body. The fuel passage 101f is formed on the inner circumferential side of the nozzle body 300b. The fuel passage 101f is formed on the upstream side of the valve 300a. A tip seal 103 is provided on the outer circumferential face of the nozzle body 300b. The tip seal 103 is provided in order to maintain air tightness in installation to the internal combustion engine.

The valve 300a includes an injection-hole formed member 301, guides 302, and a valve body 303. The valve body 303 is provided on the leading end side of a plunger rod 102.

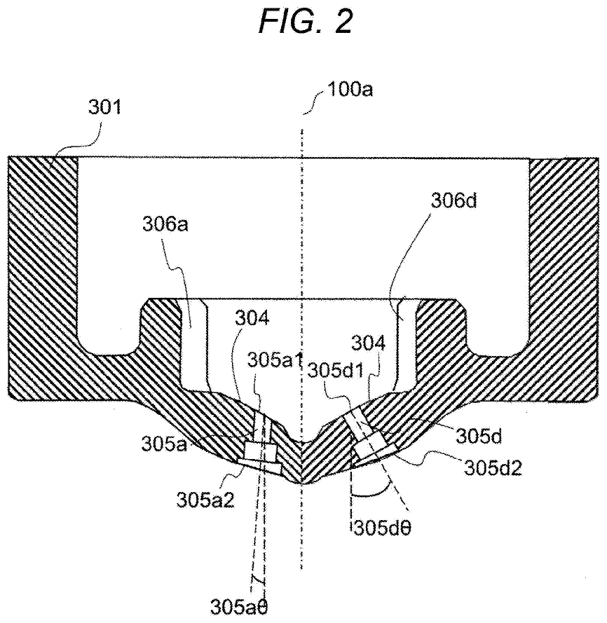

The injection-hole formed member 301 is inserted through the recessed inner-circumferential face 300ba formed at the leading end portion of the nozzle body 300b. The outer circumference of the leading end face of the injection-hole formed member 301 and the inner circumference of the leading end face of the nozzle body 300b are secured by welding. Thus, fuel is sealed between the injection-hole formed member 301 and the nozzle body 300b. The configuration of the valve 300a will be described in detail with reference to FIGS. 2 to 4.

The electromagnetic driver 400 includes a fixed iron core 401, a coil 402, a housing 403, a movable iron core 404, a first spring member 405, a third spring member 406, a second spring member 407, a plunger cap 410, and an intermediate member 414. The fixed iron core 401 is also referred to as a stationary core. The movable iron core 404 is referred to as a movable core, a mover or an armature.

The fixed iron core 401 has a fuel passage 101c at a center portion and a joint 401a with the fuel pipe 201. A spring-force adjustment member 106 that abuts against the first spring member 405 is disposed on the inner circumferential side of the fixed iron core 401.

FIG. 2 is an enlarged cross-sectional view of the injection-hole formed member 301 cut axially (longitudinally). The injection-hole formed member 301 has flow channel portions 306 radially forming a clearance with the valve body 303, a seat 304 that comes in to contact with the valve body 303 to seal fuel, and fuel injection holes 305 that inject fuel. Note that FIG. 2 illustrates a cross-sectional view including a first fuel injection hole 305a and a fourth fuel injection hole 305d among the plurality of fuel injection holes 305. The injection-hole inlet face and injection-hole outlet face of the first fuel injection hole 305a are defined as an injection-hole inlet face 305a1 and an injection-hole outlet face 305a2, respectively. In addition, as will be described in detail later, there are illustrated a first flow channel portion 306a and a fourth flow channel portion 306d formed at mutually opposed positions.

The injection hole axis connecting the center of the injection-hole inlet face 305a1 and the center of the injection-hole outlet face 305a2, of the first fuel injection hole 305a is oblique at an intersection angle 305aθ illustrated in the drawing, to the central axis line 100a of the fuel injection device 100. In addition, the injection hole axis connecting the center of the injection-hole inlet face 305d1 and the center of the injection-hole outlet face 305d2, of the fourth fuel injection hole 305d is oblique at an intersection angle 305de illustrated in the drawing, to the central axis line 100a of the fuel injection device 100. The intersection angle 305dθ is formed larger than the intersection angle 305aθ.

In the present embodiment, the seat face 304 is flush with the injection-hole inlet face 305a1 of the first fuel injection hole 305a. In addition, the seat face 304 is flush with the injection-hole inlet face 305d1 of the fourth fuel injection hole 305d. The embodiment, however, is not limited to this arrangement. For example, an injection-hole opening face 304a may be located on the downstream side of the seat face 304. This arrangement also allows change in length of the fuel injection holes 305, thereby improving the design flexibility of the injection-hole formed member 301.

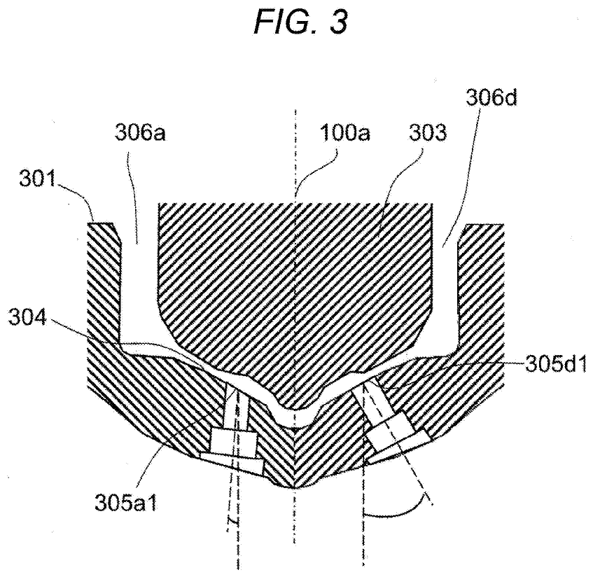

FIG. 3 is a partially enlarged view of a region denoted by reference sign 3 in FIG. 1. FIG. 3 illustrates the valve body 303 open. That is, a drive current flows through the coil 402 of the electromagnetic driver 400 to form a magnetic circuit among the fixed iron core 401, the movable iron core 404, the nozzle body 300b, and the housing 403. Thus, the movable iron core 404 is attracted to the fixed iron core 401. At this time, the movable iron core 404 is engaged with the protrusion of the outer diameter of the plunger rod 102 to move the plunger rod 102 to the upstream side. As a result, the valve body 303 also moves to the upstream side, and the valve body 303 is open such as illustrated in FIG. 3.

Note that, with the valve body 303 closed, as illustrated in FIG. 1, the first spring member 405 biases the plunger cap 410 in the downstream direction, and the third spring member 406 provided with the plunger cap 410 biases the intermediate member 414 to bias the movable iron core 404 in the downstream direction. On the other hand, the second spring member 407 biases the movable iron core 404 in the upstream direction. Here, a relationship is established in the spring force of the first spring member 405>the spring force of the third spring member 406>the spring force of the second spring member 407. Thus, with the valve body 303 closed, a clearance is formed between the upper face of the movable iron core 404 and the lower face of the protrusion of the outer diameter of the plunger rod 102. This clearance may also be referred to as an auxiliary stroke (auxiliary lift). After energization, the movable iron core 404 biased by the amount of auxiliary stroke can be moved in the upstream direction, thereby allowing improvement of the valve opening speed.

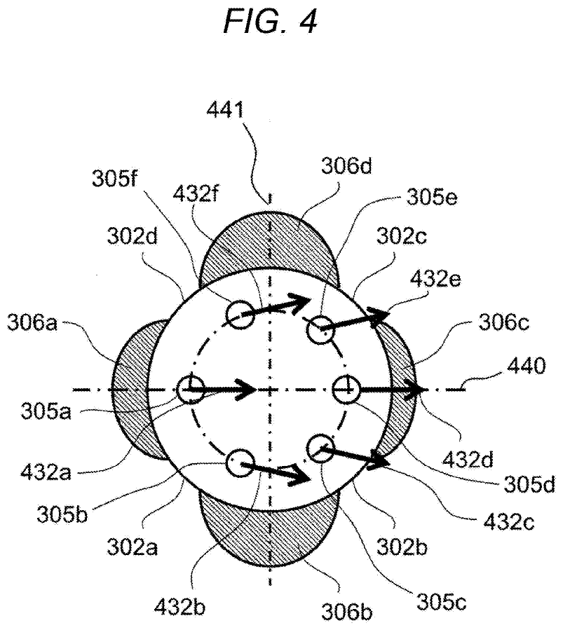

The guides 302 (see FIG. 4) are located on the inner circumferential side of the injection-hole formed member 301 and has a slight clearance (e.g., 7 um to 17 um) while serving as a guide face with the leading end side (lower end side) of the plunger rod 102. Thus, the guides 302 guide the plunger rod 102 in movement in the direction along the central axis line 100a (opening and closing valve direction). Although having a tapered leading end, the valve body 303 may also have a spherical leading end.

FIG. 4 is a view of the seat in FIG. 2 as viewed from above. The plurality of guides 302a to 302d are provided circumferentially, and the respective lengths of the guides are substantially equal. It is ideal that the guides are equal in length, in order to evenly support the valve body from the circumferential direction. In addition, preferably, the adjacent circumferential centers of the plurality of guides 302a to 302d are equispaced circumferentially.

Furthermore, in the first embodiment, with respect to the border of the oblique-direction central axis 440 orthogonal to the central axis 100a of the valve body and parallel to the oblique direction of the injection holes, the total cross-sectional area (defined as A) of the flow channel portions (306b and 306d) located orthogonally to the oblique-direction central axis 440 is formed larger than the total cross-sectional area (defined as B) of the flow channel portions (306a and 306c) each located parallelly to the oblique-direction central axis. Arrows 432a to 432f in the drawing indicate fuel injection directions projected on the sheet of FIG. 4, respectively.

For occurrence of positional shift of the valve body, in comparison with a positional shift to the oblique direction of the injection holes, a positional shift to the non-oblique direction (straight direction) of the injection holes has a larger influence on variation in the flow rate and injection direction for respective beams of spray injected from the injection holes and variation in the flow rate of injection between all the injection holes. Occurrence of positional shift of the valve body causes a flow change in the positional shift direction upstream of the respective inlets of the injection holes. For example, a positional shift of the valve body in the oblique direction of the injection holes causes change of the spray behavior of the injection direction. A large flow (main flow) is generated in the oblique direction of the injection holes (spray injection direction) upstream of the injection holes. Thus, the change of flow caused due to a minute positional shift in the oblique direction of the injection holes is relatively smaller in comparison with the main flow. On the other hand, for occurrence of positional shift of the valve body in the non-oblique direction of the injection holes, almost no flow is generated naturally in the non-oblique direction, that is, no large main flow is generated. Thus, the flow generated due to the positional shift of the valve body is to be a main flow.

Therefore, the fuel injection device of the present embodiment includes the valve body (303, 102) that sits on or separates from the seat 304; the plurality of guides (302a, 302b, 302c, and 302d) that slidably guide the valve body (303, 102); and the plurality of flow channel portions (306a, 306b, 306c, and 306d) each formed between each guide 302 (302a, 302b, 302c, and 302d) adjacent circumferentially. Then, among the plurality of flow channel portions (306a, 306b, 306c, and 306d), cross-sectional area of the first flow channel portion (306c) on a horizontal plane orthogonal to the central axis 100a of the valve body (303, 102) is smaller than each of the cross-sectional areas of the remaining flow channel portions (306a, 306b, and 306d) on the horizontal plane.

The valve body (303, 102) may shift radially in injection; however, as long as it is undetermined that in which direction the radial positional shift occurs, variation in the amount of injection will inevitably occur. Thus, in the present embodiment, the first flow channel portion (306c) has a smaller cross-sectional area such that the valve body (303, 102) in injection always shifts on the side of the first flow channel portion 306c. As a result, variation in the amount of injection can be inhibited.

Note that, the plurality of injection holes (305a to 306f) are formed downstream of the seat 304, and the first flow channel portion 306c is formed downstream in an injection-hole common oblique direction (right direction of the oblique-direction central axis 440) defined along all the plurality of injection holes (oblique directions of 305a to 306f illustrated in the figure (spray injection directions)) at the horizontal plane.

Preferably, among the plurality of flow channel portions (306a, 306b, 306c, and 306d), the cross-sectional area of the second flow channel portion 306a on a horizontal plane formed upstream (left side of the oblique-direction central axis 440) in the injection-hole common oblique direction (right direction of the oblique-direction central axis 440) is second smallest. As described above, preferably, the first flow channel portion 306c and the second flow channel portion 306a are formed at mutually opposed positions at the horizontal plane.

Furthermore, preferably, the third flow channel portion 306d is formed in the orthogonal direction 441 orthogonal to injection-hole common oblique direction (right direction of the oblique-direction central axis 440), and the cross-sectional area of the third flow channel portion 306d on the horizontal plane is larger than the cross-sectional area of the first flow channel portion 306c on the horizontal plane. Furthermore, preferably, the third flow channel portion 306d is formed in the orthogonal direction 441 orthogonal to the injection-hole common oblique direction (right direction of the oblique-direction central axis 440), and the cross-sectional area of the third flow channel portion 306d on the horizontal plane is larger than each of the cross-sectional areas of the first flow channel portion 306c and the second flow channel portion 306a on the horizontal plane.

Furthermore, preferably, the fourth flow channel portion 306b is formed opposed to the third flow channel portion 306d at the horizontal plane, and the cross-sectional area of the fourth flow channel portion 306b on the horizontal plane is larger than the cross sectional area of the first flow channel portion 306c on the horizontal plane.

Furthermore, preferably, the third flow channel portion 306d is formed in the orthogonal direction 441 orthogonal to the injection-hole common oblique direction (right direction of the oblique-direction central axis 440) and the fourth flow channel portion 306b is formed opposed to the third flow channel portion 306d at the horizontal plane, and each of the cross-sectional areas of the third flow channel portion 306d and the fourth flow channel portion 306b on the horizontal plane is larger than each of the cross-sectional areas of the first flow channel portion 306c and the second flow channel portion 306a on the horizontal plane.

As illustrated in FIG. 4, in the present embodiment, the cross-sectional area A of the flow channel portions is formed larger than the cross-sectional area B of the other flow channel portions to increase the amount of fuel to be supplied in the non-oblique direction (orthogonal direction 441). However, the present embodiment as described above is not limited this arrangement only, and the valve body can shift in a certain direction. With the configuration illustrated in FIG. 4, main flow is newly generated in the non-oblique direction (orthogonal direction 441), thereby allowing reduction in the degree of influence of flow change caused due to positional shift of the valve body in the non-oblique direction.

Furthermore, in FIG. 4, with respect to the border of the non-oblique direction axis 441 orthogonal to the central axis 100a of the valve body and perpendicular to the oblique-direction central axis, the total cross-sectional area of the flow channel portion 306c located on the oblique side of the injection holes is formed smaller than the total cross-sectional area of the flow channel portion 306a located on the non-oblique side. With this arrangement, the amount of fuel to be supplied from the flow channel portion 306a is increased in comparison with the flow channel portion 306c, and a new flow from the flow channel portion 306a to the flow channel portion 306c is generated. As a result, the main flow in the oblique direction of the injection holes (spray injection direction) is further strengthened, whereby allowing further reduction of variation in the flow rate and injection direction for respective beams of spray injected from the injection holes and variation in the flow rate of injection between all the injection holes.

### Second Embodiment

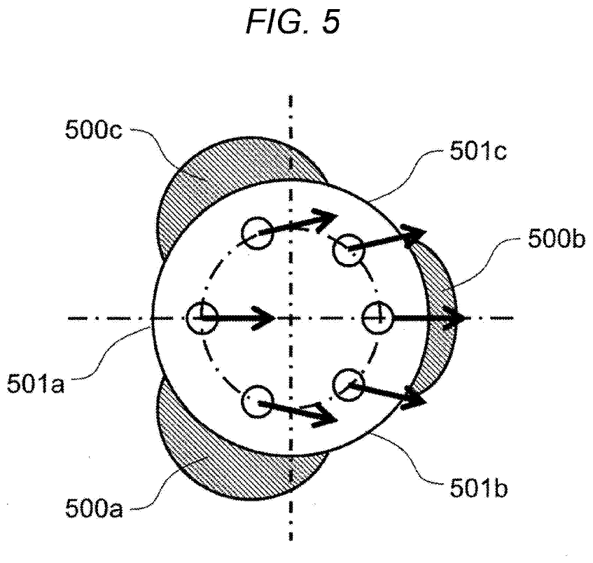

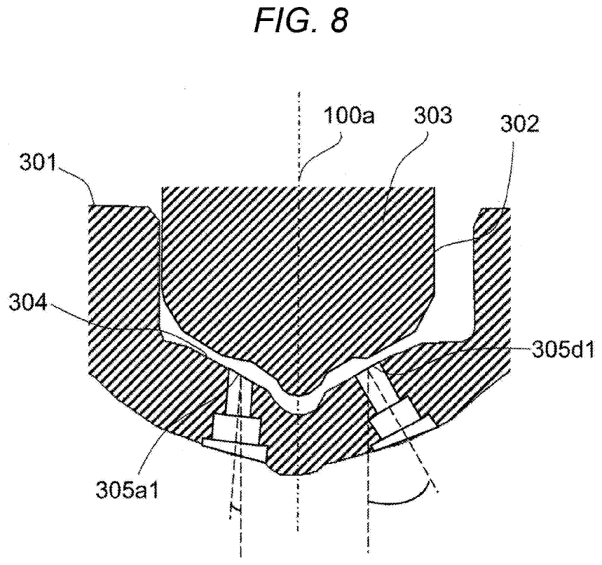

A fuel injection valve according to a second embodiment of the present invention will be described with reference to FIGS. 5 and 8. The basic configuration is similar to that of the first embodiment, and only different points will be described.

FIG. 5 exemplifies a case where the number of flow channel portions in FIG. 4 is changed to three locations. In addition, FIG. 8 illustrates a cross-sectional view at the oblique-direction central axis 440 parallel to the oblique direction of the holes. In this case, with respect to the border of the oblique-direction central axis 440 orthogonal to the central axis 100a of the valve body and parallel to the oblique direction of the injection holes, the respective total cross-sectional areas of flow channel portions (500a and 500c) located orthogonally to the oblique-direction central axis 440 is formed larger than the total cross-sectional area of a flow channel portion (500b) located parallelly to the oblique-direction central axis. In addition, the total cross-sectional area of the flow channel portion 500b located on the oblique side of the injection holes is formed smaller than the respective total cross-sectional areas of the flow channel portions (500a and 500c) located on the non-oblique side. Thus, the relationship between the respective cross-sectional areas of the flow channel portions described in the first embodiment is established. With the structure of the second embodiment, working steps can be reduced as compared with the first embodiment.

### Third Embodiment

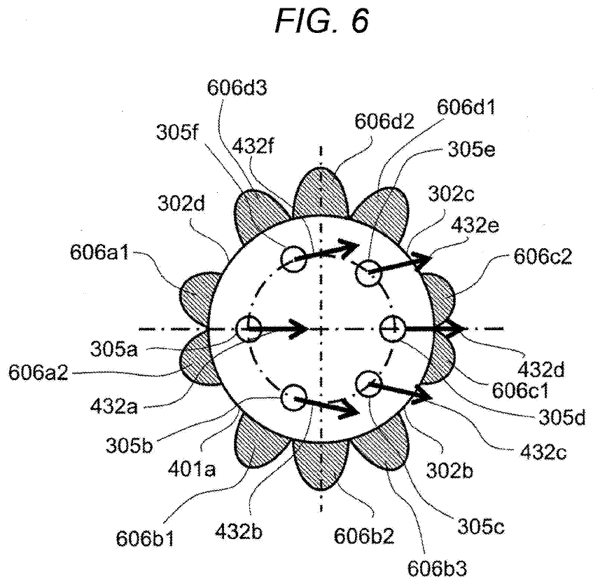

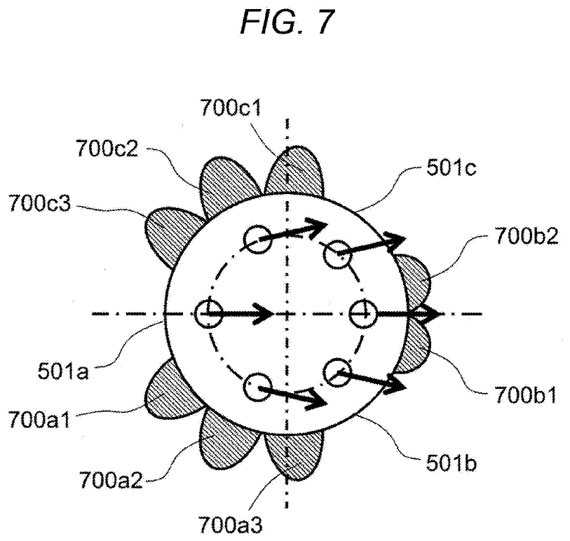

A fuel injection valve according to a third embodiment of the present invention will be described with FIGS. 6 and 7. FIGS. 6 and 7 illustrate each of the plurality of flow channel portions in FIGS. 4 and 5 including a collection of flow channels each having a smaller cross-sectional area. This arrangement facilitates change of the respective cross-sectional areas of the flow channel portions.

That is, in FIG. 6, the first flow channel portion 306c in the first embodiment is further formed by a plurality of flow channel portions (606c1, 606c2), and the second flow channel portion 306a in the first embodiment is further formed by a plurality of flow channel portions (606a1, 606a2). In the present embodiment, a first flow channel portion and a second flow channel portion each are formed by the two flow channel portions. In addition, the third flow channel portion 306d is further formed by a plurality of flow passage portions (606d1, 606d2, and 606d3), and the fourth flow channel portion 306b is further formed by a plurality of flow channel portions (606b1, 606b2, and 606b3). In the present embodiment, the number of the plurality of flow channel portions (third flow channel portion and fourth flow channel portion) in the orthogonal direction is larger than the number of the flow channel portions (first flow channel portion and second flow channel portion) of the oblique-direction central axis 440.

In FIG. 7, the first flow channel portion 500b in the second embodiment is further formed by a plurality of flow channel portions (700b1, 700b2). In the present embodiment, a first channel is formed by the two flow channel portions. Furthermore, the second flow channel portion 500c is further formed by a plurality of flow channel portions (700c1, 700c2, and 700c3), and the third flow channel portion 500a is further formed by a plurality of flow channel portions (700a1, 700a2, and 700a3). In the present embodiment, the number of the plurality of flow channel portions (second flow channel portion and third flow channel portion) in the orthogonal direction is larger than the number of the plurality of flow channel portions (first flow channel portion) of the oblique-direction central axis 440.

In each of the first to third embodiments described above, the guides and the flow channel portions are integrally formed with the member in which the fuel injection holes are formed. The invention in the present application, however, is not limited to such embodiments. For example, there may also be separately provided guides that restrict radial movement of the valve body 303, a valve seat on which the valve body 303 sits, and an injection-hole formed member having fuel injection holes formed therein. Alternatively, the present invention is also applicable to a fuel injection device, for example, having a single fuel-communication opening formed on the vertex of a conical face included in a valve seat, the single fuel-communication opening being to flow fuel downstream.

### REFERENCE SIGNS LIST

100 fuel injection device
100a central axis line
101 fuel passage
102 plunger rod
103 tip seal
104 terminal
105 connector
106 spring-force adjustment member
200 fuel supplier
201 fuel pipe
201a fuel supply port
202 O-ring
203 backup ring
300 nozzle
300a valve
300ba recessed inner-circumferential face
300c large diameter portion
301 injection-hole formed member
302 guide
303 valve body
304 seat
304a injection-hole opening face
305 fuel injection hole
306 flow channel portion
400 electromagnetic driver
401 fixed iron core
401a joint
402 coil
403 housing
404 movable iron core
405 first spring member
406 third spring member
407 second spring member
410 plunger cap
414 intermediate member
432 fuel injection direction
440 oblique-direction central axis parallel to oblique direction of injection hole
441 non-oblique direction axis orthogonal to central axis 100a of valve body and perpendicular to oblique-direction central axis parallel to oblique direction of injection hole
500 fuel flow channel portion
501 guide
606 fuel flow channel portion
700 fuel flow channel portion

1. A fuel injection device comprising:
a valve body configured to sit on or separate from a seat;
a plurality of guides configured to slidably guide the valve body; and
a plurality of flow channel portions each formed between each guide adjacent circumferentially,
wherein, among the plurality of flow channel portions, a cross-sectional area of a first flow channel portion on a horizontal plane orthogonal to a central axis of the valve body is smaller than each of cross-sectional areas of the remaining flow channel portions on the horizontal plane.

2. The fuel injection device according to claim 1, further comprising:
a plurality of injection holes formed downstream of the seat,
wherein the first flow channel portion is formed downstream in an injection-hole common oblique direction defined along all oblique directions of the plurality of injection holes at the horizontal plane.

3. The fuel injection device according to claim 2,
wherein, among the plurality of flow channel portions, a cross-sectional area of a second flow channel portion on the horizontal plane formed upstream in the injection-hole common oblique direction is second smallest.

4. The fuel injection device according to claim 3,
wherein the first flow channel portion and the second flow channel portion are formed at mutually opposed positions at the horizontal plane.

5. The fuel injection device according to claim 2,
wherein a third flow channel portion is formed in an orthogonal direction orthogonal to the injection-hole common oblique direction, and a cross-sectional area of the third flow channel portion on the horizontal plane is larger than the cross-sectional area of the first flow channel portion on the horizontal plane.

6. The fuel injection device according to claim 3,
wherein a third flow channel portion is formed in an orthogonal direction orthogonal to the injection-hole common oblique direction, and a cross-sectional area of the third flow channel portion on the horizontal plane is larger than each of the cross-sectional areas of the first flow channel portion and the second flow channel portion on the horizontal plane.

7. The fuel injection device according to claim 5,
wherein a fourth flow channel portion is formed opposed to the third flow channel portion at the horizontal plane, and a cross-sectional area of the fourth flow channel portion on the horizontal plane larger than the cross-sectional area of the first flow channel portion on the horizontal plane.

8. The fuel injection device according to claim 2,
wherein a third flow channel portion is formed in an orthogonal direction orthogonal to the injection-hole common oblique direction, and a fourth flow channel portion is formed opposed to the third flow channel portion at the horizontal plane, and each of cross-sectional areas of the third flow channel portion and the fourth flow channel portion on the horizontal plane is larger than each of the cross-sectional areas of the first flow channel portion and the second flow channel portion on the horizontal plane.
